(19) United States
(12) Patent Application Publication
(10) Pub. No.: US 2026/0158887 A1
(43) Pub. Date: Jun. 11, 2026

(54) VEHICLE ROOF WITH REMOVABLE SINGLE-PANEL COVER

(71) Applicant: Ford Global Technologies, LLC, Dearborn, MI (US)

(72) Inventors: Michael John Harmon, Northville, MI (US); Robert J. Gelardi, Plymouth, MI (US); Darren Luke, West Bloomfield, MI (US); Ricardo Haruo Sugimoto, Camaçari (BR); Justin D. Sorum, Royal Oak, MI (US); Abbas Ghamlouche, Dearborn, MI (US)

(21) Appl. No.: 18/973,280

(22) Filed: Dec. 9, 2024

(51) Int. Cl. B60J 7/11

(52) U.S. Cl. CPC B60J 7/11

(57) ABSTRACT

A motor vehicle may include a roof including a roof opening. The roof opening may be a majority of the roof by area. The motor vehicle may further include a single panel configured to attach to the roof to cover an entire roof opening and to detach from the roof such that the entire roof opening is uncovered.

### TECHNICAL FIELD

This disclosure relates to a motor vehicle including a roof with a removable, single-panel cover.

### BACKGROUND

Motor vehicles, including sport utility vehicles (SUVs), are known to include roofs that incorporate roof openings. These roof openings are configured be selectively uncovered, enabling passengers to enjoy the air and natural elements while maintaining the option for full coverage when needed.

### SUMMARY

In some aspects, the techniques described herein relate to a motor vehicle, including: a roof including a roof opening, wherein the roof opening is a majority of the roof by area; and a single panel configured to attach to the roof to cover an entire roof opening and to detach from the roof such that the entire roof opening is uncovered.

In some aspects, the techniques described herein relate to a motor vehicle, wherein the roof opening exhibits an area within a range of 65-85% of the area of the roof.

In some aspects, the techniques described herein relate to a motor vehicle, wherein the roof opening exhibits an area of substantially 75% of the area of the roof.

In some aspects, the techniques described herein relate to a motor vehicle, wherein the panel is made of a metallic material.

In some aspects, the techniques described herein relate to a motor vehicle, wherein the panel is made of steel.

In some aspects, the techniques described herein relate to a motor vehicle, wherein a plurality of fasteners are configured to hold the panel relative to the roof.

In some aspects, the techniques described herein relate to a motor vehicle, wherein the fasteners are accessible from an interior of the motor vehicle.

In some aspects, the techniques described herein relate to a motor vehicle, wherein the panel includes threaded openings configured to interface with threaded shanks of the fasteners.

In some aspects, the techniques described herein relate to a motor vehicle, wherein: a ledge projects about the roof opening, the ledge is configured to support the panel, the ledge includes openings, and the fasteners project through the openings in the ledge.

In some aspects, the techniques described herein relate to a motor vehicle, wherein: the ledge includes a plurality of tabs projecting inward from the ledge, and each of the tabs includes one of the openings.

In some aspects, the techniques described herein relate to a motor vehicle, wherein heads of the fasteners are configured to contact the tabs when the threaded shanks of the fasteners are interfaced with threaded openings of the panel.

In some aspects, the techniques described herein relate to a motor vehicle, wherein a seal is arranged on the ledge.

In some aspects, the techniques described herein relate to a motor vehicle, wherein the seal is configured to directly contact the panel when the panel covers the roof opening.

In some aspects, the techniques described herein relate to a motor vehicle, wherein: the panel includes at least one lever rotatable between a first position and a second position, when the panel is in a closed position and the lever is in the first position, the lever is configured to prevent movement of the panel relative to the roof, and when the panel is in the closed position and the lever is in the second position, the lever is configured to not interfere with movement of the panel relative to the roof.

In some aspects, the techniques described herein relate to a motor vehicle, wherein the panel is opaque.

In some aspects, the techniques described herein relate to a method, including: removing a single panel from a roof, wherein the single panel is sized and shaped to cover an entire roof opening of the roof, wherein the roof opening is a majority of the roof by area.

In some aspects, the techniques described herein relate to a method, wherein the roof opening exhibits an area within a range of 65-85% of the area of the roof.

In some aspects, the techniques described herein relate to a method, wherein the roof opening exhibits an area of substantially 75% of the area of the roof.

In some aspects, the techniques described herein relate to a method, wherein a plurality of fasteners are configured to hold the panel relative to the roof.

In some aspects, the techniques described herein relate to a method, wherein a plurality of levers are configured to hold the panel relative to the roof.

### BRIEF DESCRIPTION OF THE DRAWINGS

FIG. 1 illustrates a front perspective view of an example motor vehicle, which in this example is an SUV.

FIG. 2 is a top perspective view of a roof of the motor vehicle, with a panel fully covering a roof opening.

FIG. 3 is a view similar to FIG. 2, with the panel removed from the vehicle such that the roof opening is uncovered.

FIG. 4 is an expanded view of the panel and fasteners relative to the roof.

FIG. 5 is a top view of a portion of the roof, and illustrates an example arrangement of a ledge.

FIG. 6 is a cross-sectional view of a portion of the roof, and illustrates an example arrangement between the panel and the ledge.

FIG. 7 is a view of an example lever relative to a portion of the roof and the panel.

### DETAILED DESCRIPTION

This disclosure relates to a motor vehicle including a roof with a removable, single-panel cover. Among other benefits, this disclosure allows a user to remove a single-panel to expose an entire roof opening. With the single panel removed, the user can enjoy a relatively large roof opening or interface the vehicle with another type of roof covering.

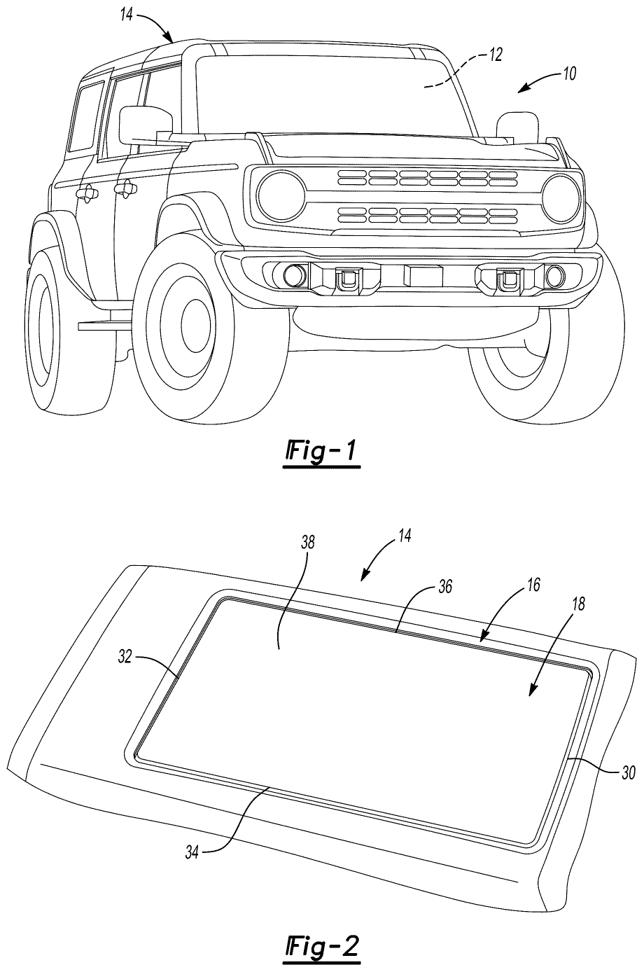

FIG. 1 illustrates a motor vehicle 10 (“vehicle 10”), which in this example is a sport utility vehicle (SUV). While an SUV is shown, the vehicle 10 could be another type of vehicle.

The vehicle 10 includes a passenger compartment, or passenger cabin, 12. A roof 14 is vertically above the passenger compartment 12. The roof 14 is defined by a body and/or a frame of the vehicle 10, and is generally configured to cover the passenger compartment 12 to protect the occupants from the weather and other elements.

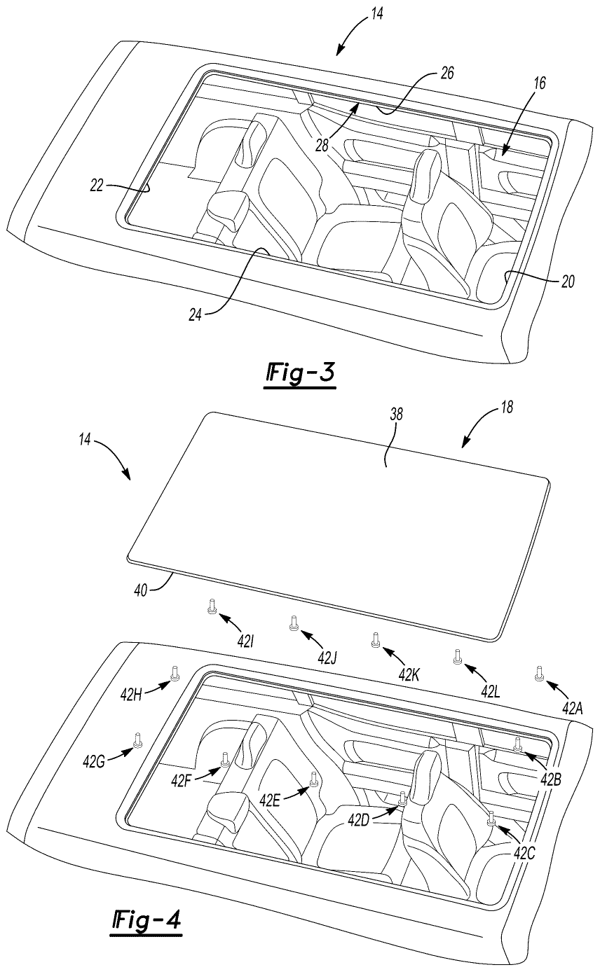

With reference to FIG. 2, the roof 14 includes a roof opening 16. The roof opening 16 is fully covered by a panel 18 in FIG. 2. In FIG. 3, the panel 18 has been removed from the vehicle 10 such that the roof opening 16 is uncovered by the panel 18. The panel 18 is a single panel configured to attach to the roof 14 to cover the entire roof opening 16 and to detach from the roof 14 such that the entire roof opening 16 is uncovered.

The roof opening 16 is defined between a first end 20, a second end 22 opposite the first end 20, a first side 24 extending between the first and second ends 20, 22, and a second side 26 opposite the first side 24 and extending between the first and second ends 20, 22. The roof opening 16 is substantially rectangular in this example. The roof opening 16 is completely circumscribed by the roof 14, in this example.

Further, in this example, the roof opening 16 is a majority of the roof 14 by area, meaning roof opening 16 exhibits an area greater than 50% of the area of the roof 14 (inclusive of the roof opening 16). In a more specific embodiment, the roof opening 16 exhibits an area within a range of 65-85% of the area of the roof 14 (inclusive of the roof opening 16). In an even more specific embodiment, the roof opening 16 exhibits an area of substantially 75% of the area of the roof 14 (inclusive of the roof opening 16).

An elastomeric seal 28 (FIG. 3) may extend about the entire perimeter of the roof opening 16. When the panel 18 is configured as in FIG. 2, the panel 18 may be held in contact with the elastomeric seal 28 to resist ingress of water, dirt, etc., relative to the passenger compartment 12.

The panel 18 includes a first end 30, a second end 32 opposite the first end 30, a first side 34 extending between the first and second ends 30, 32, and a second side 36 opposite the first side 34 and extending between the first and second ends 30, 32. The panel 18 further includes an upper surface 38 and a lower surface 40 (FIG. 4). The panel 18 is made of a rigid or semi-rigid material. In a particular example, the panel 18 is made of a single piece of metallic material, such as steel. The panel 18 is a single, integrated panel (i.e., it is not made of two or more interconnected panels) and is sized and shaped to fit relative to the roof 14 to fully cover the roof opening 16. In this regard, the panel 18 is configured to cover 100% of the roof opening 16. In a particular example, the panel 18 is not made of a transparent material, such as glass, but is instead made of an opaque material.

The panel 18 is attachable and detachable from the roof 14. In one aspect of this disclosure, a plurality of fasteners 42A-42L (FIG. 4) are configured to hold the panel 18 relative to the roof 14. While a particular quantity of fasteners is shown in FIG. 4, this disclosure is not limited to any particular quantity of fasteners.

In this example, fasteners 42A-42C are arranged adjacent ends 20, 30, fasteners 42D-42F are arranged adjacent sides 24, 34, fasteners 42G-42I are arranged adjacent ends 22, 32, and fasteners 42J-42L are arranged adjacent sides 26, 36. Fasteners 42A, 42C, 42G, and 42I are arranged relative to corners of the roof opening 16 and the panel 18.

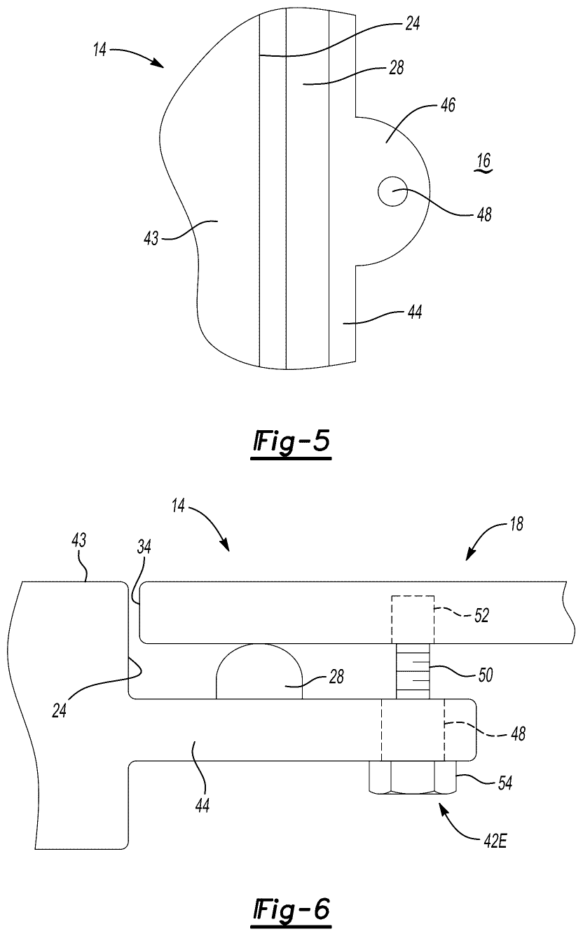

An example interface between the roof 14, the panel 18, and the fasteners will now be described relative to FIGS. 5 and 6. FIGS. 5 and 6 are views of a portion 43 of the roof 14 adjacent side 24. In this example, a ledge 44 projects about an entire perimeter of the roof opening 16. The ledge 44 is continuous, in this example, and projects inward from ends 20, 22, and sides 24, 26.

The ledge 44 is configured to support the seal 28 thereon. The ledge 44 is further configured to support the panel 18 thereon. The panel 18 and ledge 44 are configured to interface with fasteners 42A-42L. In this example, the ledge 44 includes tabs, such as tab 46, projecting from the remainder of the ledge 44. The tab 46 includes a through-opening 48. In order to attach the panel 18 to the roof 14, one of the fasteners, which in FIG. 6 is fastener 42E, is configured such that a threaded shank 50 of the fastener 42E projects through opening 48 and into a threaded bore 52 within the panel 18. A head 54 of the fastener 42E abuts a surface of the tab 46 opposite panel 18. The orientation of the head 54 is such that a user can access the fastener 42E from an interior of the vehicle 10. The head 54 may include an interface configured to fit with a particular tool.

The force applied to the panel 18 by the fastener 42E brings the panel 18 into contact with seal 28 and holds the panel 18 in place. While an example interface has been shown relative to fastener 42E, it should be understood that the panel 18 and ledge 44 are configured to interface with the other fasteners 42A-42D, 42F-42L in substantially the same manner.

In another embodiment of this disclosure, the panel 18 includes a plurality of levers configured to be manually configured so as to selectively attach the panel 18 to the roof 14. Reference to the levers being manually configurable means the levers are able to be configured without powered electrical components, such as motors, drives, actuators, etc., and further refers to the cover/panels being configurable by a user by hand and without the use of tools such as screwdrivers, drills, wrenches, etc.

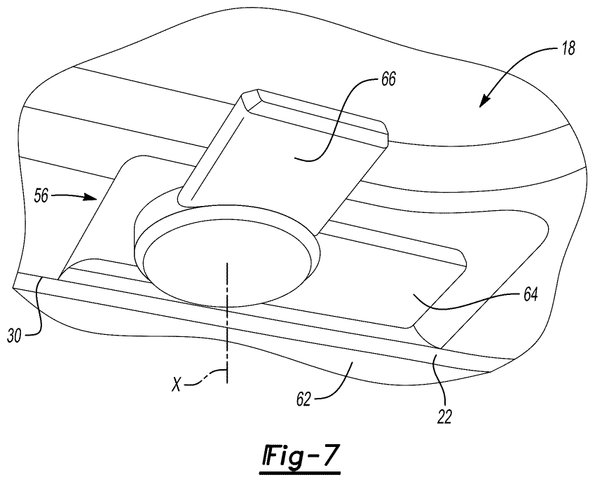

An example lever 56 is shown in FIG. 7. Lever 56 is representative of a number of levers that may be arranged about the perimeter of the panel 18. Lever 56 is disengaged with a portion 62 of the roof 14 adjacent end 22 in this example. Specifically, lever 56 includes a first arm 64 and a second arm 66. The first arm 64 may include a cam surface configured to engage a corresponding surface of portion 62. The second arm 66 is configured as a handle and is able to be grasped by a user. A user can grasp second arm 66 to rotate the lever 56 about axis X, such that the first arm 64 comes selectively into and out of engagement with portion 62. In the configuration of FIG. 7, the lever 56 is configured so as to not prevent movement of panel 18 relative to the roof 14. When the lever 56 is rotated such that the first arm 64 contacts the portion 62, such as when the lever 56 is rotated substantially 90° about axis X relative to configuration in FIG. 7, the lever 56 is configured to prevent movement of the panel 18 relative to the roof 14.

It should be understood that terms such as “about,” “substantially,” and “generally” are not intended to be boundaryless terms, and should be interpreted consistent with the way one skilled in the art would interpret those terms. Further, directional terms such as “upper,” “forward,” “rearward,” “upward,” “downward,” “vertical,” “horizontal,” “below,” “top,” “bottom,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a roof including a roof opening, wherein the roof opening is a majority of the roof by area; and
a single panel configured to attach to the roof to cover an entire roof opening and to detach from the roof such that the entire roof opening is uncovered.

2. The motor vehicle as recited in claim 1, wherein the roof opening exhibits an area within a range of 65-85% of the area of the roof.

3. The motor vehicle as recited in claim 2, wherein the roof opening exhibits an area of substantially 75% of the area of the roof.

4. The motor vehicle as recited in claim 1, wherein the panel is made of a metallic material.

5. The motor vehicle as recited in claim 4, wherein the panel is made of steel.

6. The motor vehicle as recited in claim 1, wherein a plurality of fasteners are configured to hold the panel relative to the roof.

7. The motor vehicle as recited in claim 6, wherein the fasteners are accessible from an interior of the motor vehicle.

8. The motor vehicle as recited in claim 7, wherein the panel includes threaded openings configured to interface with threaded shanks of the fasteners.

9. The motor vehicle as recited in claim 8, wherein:
a ledge projects about the roof opening,
the ledge is configured to support the panel,
the ledge includes openings, and
the fasteners project through the openings in the ledge.

10. The motor vehicle as recited in claim 9, wherein:
the ledge includes a plurality of tabs projecting inward from the ledge, and
each of the tabs includes one of the openings.

11. The motor vehicle as recited in claim 10, wherein heads of the fasteners are configured to contact the tabs when the threaded shanks of the fasteners are interfaced with threaded openings of the panel.

12. The motor vehicle as recited in claim 9, wherein a seal is arranged on the ledge.

13. The motor vehicle as recited in claim 12, wherein the seal is configured to directly contact the panel when the panel covers the roof opening.

14. The motor vehicle as recited in claim 1, wherein:
the panel includes at least one lever rotatable between a first position and a second position,
when the panel is in a closed position and the lever is in the first position, the lever is configured to prevent movement of the panel relative to the roof, and
when the panel is in the closed position and the lever is in the second position, the lever is configured to not interfere with movement of the panel relative to the roof.

15. The motor vehicle as recited in claim 1, wherein the panel is opaque.

16. A method, comprising:
removing a single panel from a roof, wherein the single panel is sized and shaped to cover an entire roof opening of the roof, wherein the roof opening is a majority of the roof by area.

17. The method as recited in claim 16, wherein the roof opening exhibits an area within a range of 65-85% of the area of the roof.

18. The method as recited in claim 17, wherein the roof opening exhibits an area of substantially 75% of the area of the roof.

19. The method as recited in claim 16, wherein a plurality of fasteners are configured to hold the panel relative to the roof.

20. The method as recited in claim 16, wherein a plurality of levers are configured to hold the panel relative to the roof.
